(19) United States
(12) Patent Application Publication
(10) Pub. No.: US 2021/0243726 A1
(43) Pub. Date: Aug. 5, 2021

(54) COMMUNICATION APPARATUS

(71) Applicant: NTT DOCOMO, INC., Tokyo (JP)

(72) Inventors: Ryosuke Osawa, Chiyoda-ku, Tokyo (JP); Shinpei Yasukawa, Chiyoda-ku, Tokyo (JP); Kazuki Takeda, Tokyo (JP); Satoshi Nagata, Tokyo (JP)

(73) Assignee: NTT DOCOMO, INC., Tokyo (JP)

(21) Appl. No.: 17/049,251

(22) PCT Filed: Apr. 24, 2018
(86) PCT No.: PCT/JP2018/016687

§ 371 Date: Oct. 20, 2020

(51) Int. Cl. H04W 72/02; H04W 72/04; H04W 4/40

(52) U.S. Cl. CPC H04W 72/02; H04W 4/40; H04W 72/0406

(57) ABSTRACT

A disclosed communication apparatus includes a receiver configured to receive control information for a specified communication apparatus from a base station; and a transmitter configured to identify, based on the control information, a resource used by the specified communication apparatus for communication, and to execute a process of not performing transmission using the identified resources.

### TECHNICAL FIELD

The present invention relates to a communication apparatus in a radio communication system.

### BACKGROUND ART

In LTE (Long Term Evolution) and the successor system of LTE (for example, LTE-A (LTE Advanced), NR (New Radio) (also called 5G)), a D2D (Device to Device) technology in which user devices directly communicate with each other without having intervention from a radio base station has been studied. In LTE (Long Term Evolution) and LTE successor systems (e.g., LTE-A (LTE Advanced), NR (New Radio) (also called 5G)), a sidelink (also called D2D (Device to Device) in which communication apparatuses such as UE communicate directly without using base stations has been studied (Non-Patent Document 1).

In addition, the realization of V2X (Vehicle to Everything) has been studied, and the specification is under way. Here, V2X is part of the Intelligent Transport Systems (ITS), and as illustrated in FIG. 1, it is a generic term for V2V (Vehicle to Vehicle), which means a form of communication between vehicles and roadside aircrafts (RSU: Road-Side Unit), V2N (Vehicle to Nomadic device), which means a form of communication between vehicles and mobile devices of drivers, and V2P (Vehicle to Pedestrian), which means a form of communication between vehicles and mobile devices of pedestrians.

### RELATED ART DOCUMENT

### Non-Patent Document

[NON-PATENT DOCUMENT 1] 3GPP TS 36.213 V14.3.0 (2017-06)

### SUMMARY OF THE INVENTION

### Problem to be Solved by the Invention

With regard to V2X, a technique is being studied in which multiple communication apparatuses (e.g., a communication apparatus installed in a vehicle) are grouped, and communication apparatuses within the group transmit data (e.g., data sensed by the sensor) to a representative communication apparatus in a sidelink, and a representative communication apparatus transmits the aggregated data to a base station. However, in the art, sidelink (SL) communication may interfere with uplink (UL) or downlink (DL) communication between the representative communication apparatus and the base station.

The present invention has been made in light of the above-point, and the object of the present invention is intended to provide a technology that allows communication by sidelink to avoid interfering with communication between a particular communication apparatus and a base station.

### Means for Solving the Problem

According to the disclosed technique, a communication apparatus includes

a receiver configured to receive control information for a specified communication apparatus from a base station; and

a transmitter configured to identify, based on the control information, a resource used by the specified communication apparatus for communication, and to execute a process of not performing transmission using the identified resources.

### Advantageous Effect of the Present Invention

According to the disclosed technique, a technique is provided that allows communication by sidelink to avoid interfering with communication between a particular communication apparatus and a base station.

### BRIEF DESCRIPTION OF THE DRAWINGS

FIG. 1 is a diagram illustrating V2X;

FIG. 2A is a diagram illustrating a sidelink;

FIG. 2B is a diagram illustrating a sidelink;

FIG. 3 is a diagram illustrating a MAC PDU used for sidelink communication;

FIG. 4 is a diagram illustrating a format of an SL-SCH subheader;

FIG. 5 is a diagram illustrating an example of a channel structure used in a sidelink;

FIG. 6 is a diagram illustrating a configuration example of a radio communication system according to an embodiment;

FIG. 7 is a diagram illustrating a resource selection operation of a communication apparatus;

FIG. 8 is a diagram illustrating an operation example in which information is aggregated and transmitted;

FIG. 9 is a diagram illustrating an operation example of the first embodiment;

FIG. 10 is a diagram illustrating an operation example of the first embodiment;

FIG. 11 diagram illustrating an operation example of the first embodiment;

FIG. 12 is a diagram illustrating an operation example of the first embodiment;

FIG. 13 is a diagram illustrating an operation example of the first embodiment;

FIG. 14 is a diagram illustrating an operation example of a second embodiment;

FIG. 15 is a diagram illustrating an operation example of a third embodiment;

FIG. 16 is a diagram illustrating a combined operation of the second embodiment and the third embodiment;

FIG. 17 is a diagram illustrating an operation example of a fourth embodiment;

FIG. 18 is a diagram illustrating an operation example of the fourth embodiment;

FIG. 19 is a diagram illustrating an operation example of the fifth embodiment;

FIG. 20 is a diagram illustrating a functional configuration example of a base station 10 according to an embodiment;

FIG. 21 is a diagram illustrating an example of a functional configuration of a communication apparatus 20 according to an embodiment; and

FIG. 22 is a diagram illustrating an example of a functional configuration of a communication apparatus 20 according to an embodiment.

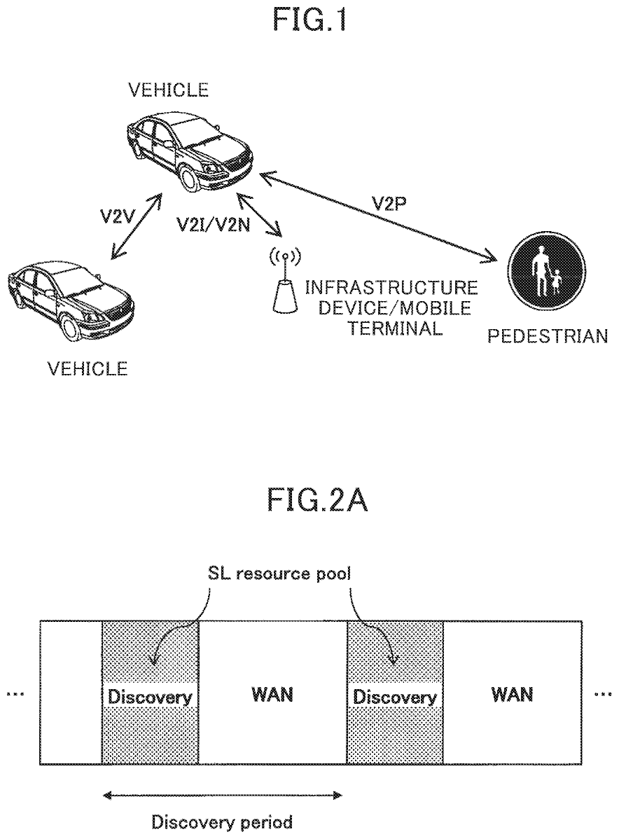

### EMBODIMENTS FOR CARRYING OUT THE INVENTION

The following describes embodiments of the present invention (present embodiments) with reference to the accompanying drawings. Note that the embodiments described below are merely examples and the embodiments to which the present invention is applied are not limited to the following embodiments.

Although the method of direct communication between communication apparatuses in this embodiment is assumed to be a sidelink (SL) of LTE or NR, the method of direct communication is not limited to this method. In addition, the name “sidelink” is an example, and the name “sidelink” may not be used, and the UL may include the function of SL.

UL and SL may also be distinguished by differences in one or more of the time resources, frequency resources, time-frequency resources, reference signals referenced to determine Pathloss in transmission power control, or reference signals used to synchronize (PSSS/SSSSS).

For example, in UL, the reference signal of antenna port X is used as a reference signal to determine Pathloss in the transmission power control, and in SL (including UL used as SL), the reference signal of antenna port Y is used as the reference signal to determine Pathloss in the transmission power control.

Further, although the present embodiment mainly envisions the embodiment in which the communication apparatus is installed in a vehicle, embodiments or the present invention are not limited to this embodiment. For example, the communication apparatus may be a human-held terminal, or the communication apparatus may be a drawn or airborne device.

### Outline of Sidelink

In this embodiment, since the sidelink is the basic technology, an outline of the sidelink will be first described as a basic example. An example of the technique described herein is a technique specified in Rel. 14, etc. of 3GPP. The art may be used in NR, or in NR, techniques differing from the art may be used.

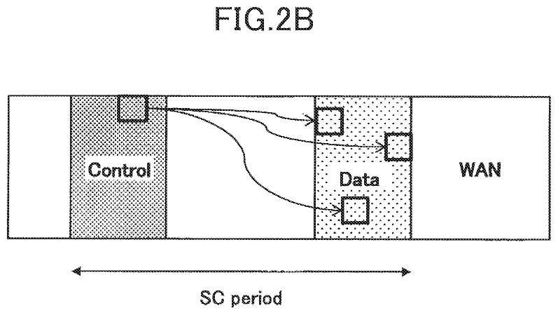

Sidelink is broadly divided into “discovery” and “communication. For “discovery,” as illustrated in FIG. 2A, a resource pool for the Discovery message is allocated for each Discovery period, and the communication apparatus (called the UE) transmits a Discovery message (discovery signal) within its resource pool. More specifically, there are Type 1 and Type 2b. In Type 1, the communication apparatus selects the transmission resource from the resource pool autonomously. In Type 2b, quasi-static resources are assigned by upper-layer signaling (e.g., RRC signals).

As illustrated in FIG. 2B, for “communication,” a resource pool for SCI (Sidelink Control Information)/data transmission is periodically allocated. The transmitter notifies the receiver of the data transmission resource (PSSCH resource pool) etc. using the resource selected from the control resource pool (PSSCCH resource pool) and transmits the data using the data transmission resource. For “communication,” more specifically, there are modes 1 and 2. In mode 1, resources are dynamically allocated by (E) PDCCH sent from the base station to the communication apparatus. In mode 2, the communication apparatus selects the transmission resource autonomously from the resource pool. Resource pools are notified or predefined by the SIB.

In addition, in the Rel-14, there are modes 3 and 4 in addition to modes 1 and 2. In Rel-14, the SCI and data can be transmitted simultaneously (in one sub-frame) in a resource block adjacent to the frequency direction. SCI may be referred to as SA (scheduling assignment).

The channel used for “Discovery” is called PSDCH (Physical Sidelink Discovery Channel), and the channel for transmitting control information such as SCI in “Communication” is called PSSCCH (Physical Sidelink Control Channel), and the channel for transmitting data is called PSSCH (Physical Sidelink Shared Channel). PSCCH and PSSH have a PUSCH-based structure with DMRS (Demodulation Reference Signal) inserted.

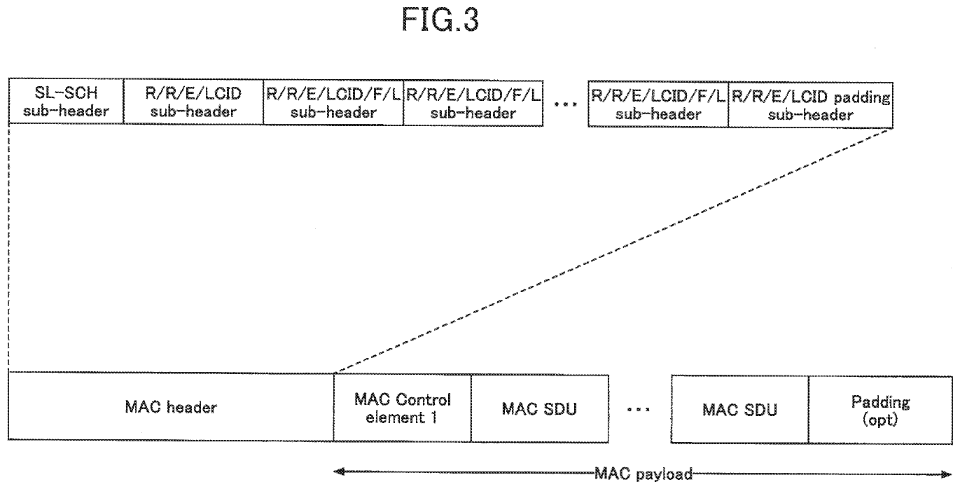

The MAC (Medium Access Control) PDU (Protocol Data Unit) used for the sidelink is composed of at least MAC header, MAC control element, MAC SDU (Service Data Unit), and padding, as illustrated in FIG. 3. The MAC PDU may contain other information. The MAC header consists of one SL-SCH (Sidelink Shared Channel) subheader and one or more MAC PDU subheaders.

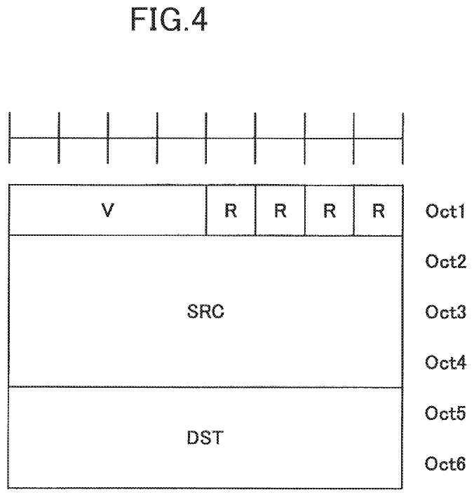

As illustrated in FIG. 4, the SL-SCH subheader consists of the MAC PDU format version (V), source information (SRC), destination information (DST), and Reserved bit(R), etc. V is assigned to the beginning of the SL-SCH subheader and indicates the MAC PDU format version used by the communication apparatus source information is set to information about the source. The source information may be set to an identifier for the ProSe UE ID. Information about the destination is set in the destination information. The destination information may contain information about the ProSe Layer-2 Group ID of the destination.

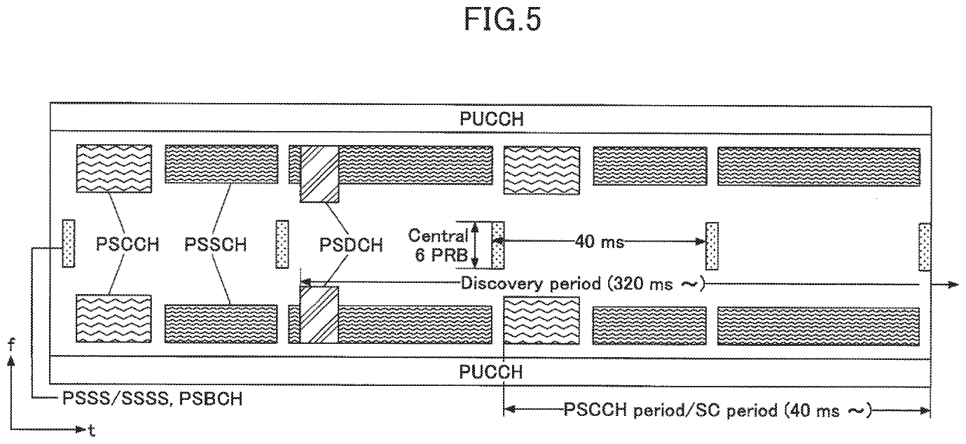

An example of a sidelink channel structure is illustrated in FIG. 5. As illustrated in FIG. 5, the PSCCH resource pool and the PSSCH resource pool used for “communication” are assigned. In addition, the PSDCH resource pool used for “discovery” is assigned at a period longer than the period of the “communication” channel.

In addition, PSSS (Primary sidelink Synchronization Signal) and SSSSS (Secondary sidelink Synchronization Signal) are used as synchronization signals for side drinks. For example, a PSBCH (Physical Sidelink Broadcast Channel) that transmits broadcast information (broadcast information) such as system bandwidth, frame number, and resource configuration information of a sidelink is used for out-of-coverage operations. PSSS/SSSSSSS and PSBCH are transmitted, for example, in one sub-frame. PSSS/SSSSSSS may be referred to as SSLSS.

The V2X envisioned in this embodiment is a method pertaining to “communication.” However, in this embodiment, there may be no distinction between “communication” and “discovery”. Also, the techniques of this embodiment may be applied in “discovery”.

### System Configuration

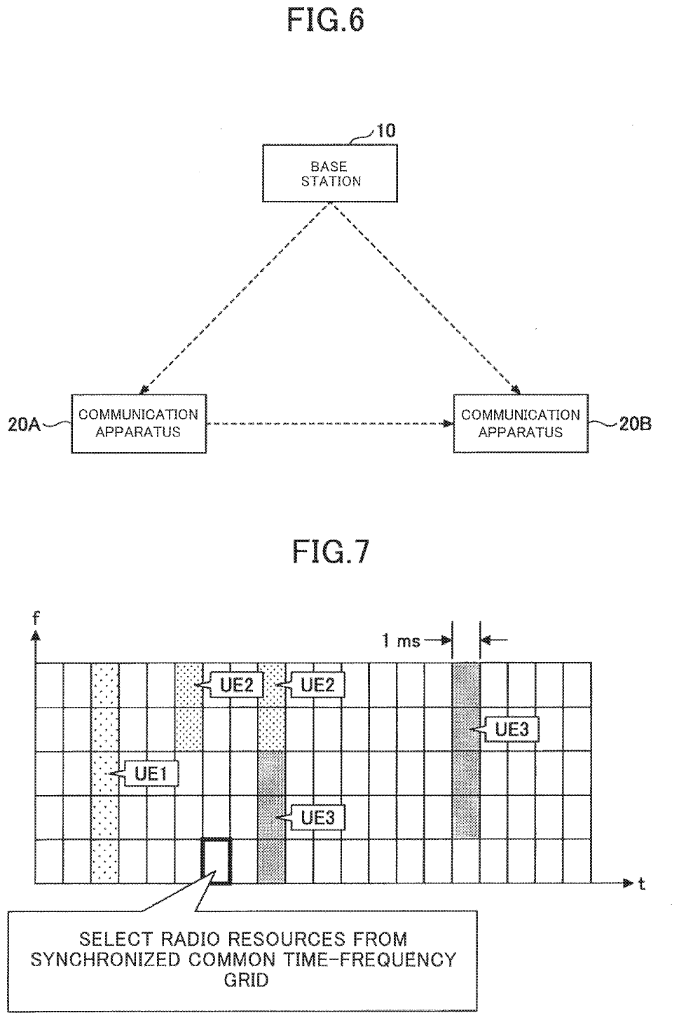

FIG. 6 is a diagram illustrating a configuration example of a radio communication system according to the present embodiment. As illustrated in FIG. 6, the radio communication system according to this embodiment includes a base station 10, a communication apparatus 20A, and a communication apparatus 20B. Although there are actually many communication apparatuses, FIG. 6 illustrates the communication apparatus 20A and the communication apparatus 20B as examples.

In FIG. 6, although the communication apparatus 20A and the communication apparatus 20B are intended to be the transmitting side and the receiving side, both the communication apparatus 20A and the communication apparatus 20B have both transmitting and receiving functions. Hereinafter, when the communication apparatuses 20A, 20B, etc. are not particularly distinguished, they are simply described as “communication apparatuses 20” or “communication apparatuses”. “In FIG. 6, although both communication apparatus 20A and communication apparatus 20B are illustrated in coverage as an example, the operation in this embodiment can be applied to any of the following cases: where all communication apparatus 20 is within coverage; where some communication apparatus 20 is within coverage; where the other communication apparatus 20 is outside coverage; and where all communication apparatus 20 is outside coverage.

In this embodiment, the communication apparatus 20 is a device installed in a vehicle, such as a car, and has a cellular communication function as a U in an LTE or NR and a sidelink function. Further, the communication apparatus 20 includes a function. Further, acquiring report information (position, event information, etc.) such as a GPS device, a camera, various sensors, etc. The communication apparatus 20 may also be a common portable terminal (e.g., a smartphone). The communication apparatus 20 may also be an RSU. The RSU may be a UE-type RSU with the function of the UE or may be a gNB-type RSU with the function of the base station.

Note herein that the communication apparatus 20 does not need to be an apparatus of one housing. For example, even if various sensors are distributed in a vehicle, the apparatus including the various sensors is the communication apparatus 20. The communication apparatus 20 may also include a function for transmitting and receiving various sensors and data without various sensors.

In addition, the processing content of the sidelink transmission of the communication apparatus 20 is basically the same as that of the UL transmission processing in LTE or NR. For example, the communication apparatus 20 scrambles the code word of the transmitted data, modulates it to generate a complex-valued symbols, maps the complex-valued symbols to one or two layers, and precodes. The precoded complex-valued symbol is then mapped to the resource element to generate a transmitted signal (e.g., complex-valued time-domain SC-FDMA signal) and transmitted from each antenna port.

In addition, the base station 10 has a function of cellular communication as the base station 10 in the LTE or NR and a function for enabling communication of the communication apparatus 20 in the present embodiment (e.g., resource pool configuration, resource allocation, etc.). The base station 10 may also be a RSU (gNB type RSU).

In the radio communication system according to the present embodiment, the signal waveform used by the communication apparatus 20 for the SL or UL may be an OFDMA, an SC-FDMA, or other signal waveform. In the radio communication system according to the present embodiment, as an example, a frame includes multiple sub-frames (e.g., 10 sub-frames) is formed in the time direction, and the frequency direction is comprised of multiple sub-carriers. One subframe is an example of the Transmission Time Interval (TTI). Long periods other than subframes may be used as transmit time intervals. The number of slots per sub-frame may also be determined depending on the sub-carrier interval. The number of symbols per slot may also be 14.

In this embodiment, the communication apparatus 20 may take any mode in which a resource for transmitting an SL signal is autonomously selected (hereinafter referred to as mode 4), or in which a resource for transmitting an SL signal is allocated from the base station 10 (hereinafter referred to as mode 3). The mode is set, for example, from the base station 10 to the communication apparatus 20.

As illustrated in FIG. 7, the communication apparatus in mode 4 (illustrated as UE in FIG. 7) selects a radio resource from a synchronized common time-frequency grid. For example, the communication apparatus 20 senses in the background to identify, as candidate resources, resources that exhibit good sensing results and not reserved by other communication apparatuses, and selects resources to be used for transmission from candidate resources.

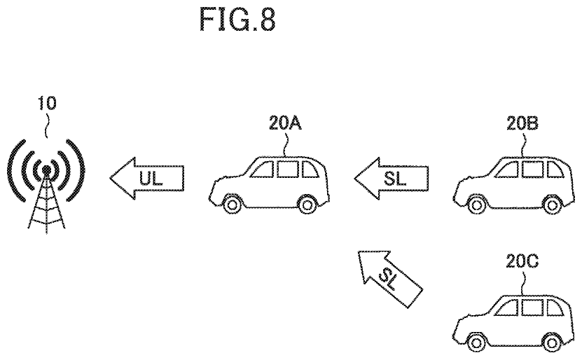

As an example of communication using V2X, the following technique has been studied, in which multiple communication apparatuses 20 (communication apparatuses 20A to 20C in FIG. 8) are grouped together, and the communication apparatuses 20B and 20C in the group transmit data (e.g., data sensed by the sensor) to the communication apparatus 20A representing the group by SL, and transmit data aggregated by the representative communication apparatus 20A to the base station 10 by UL as illustrated in FIG. 8.

### Issues

In SL in the art (e.g., non-patent document 1), UL/DL and SL use different frequency bands.

However, SL may be diverted to non-ITS purposes in the future. In such a case, DL/UL and SL may use a common frequency band. In this case, when performing communication based on grouping as illustrated in FIG. 8, if other communication apparatuses in the group communicate with SL while the representative communication apparatus communicates with UL/DL, the communication of the SL may interfere with the communication of UL/DL, which may interfere with the communication between the representative communication apparatus and the base station 10.

Hereinafter, an exemplary embodiment of a technique for solving the above-described problems will be described. Although Embodiments 1 to 5 will be described below, Embodiments 1 to 5 may be performed independently, or any two, any three, any four, or all may be combined.

In the following first to third embodiments, is assumed that a group of multiple communication apparatuses and a representative communication apparatus within the group have already been determined. The method for determining the group and the representative communication apparatus will be described in the fourth embodiment.

In the following first to third embodiments, a communication subject to control of transmission prohibition/transmission permission is basically an SL transmission performed by a communication apparatus other than a representative communication apparatus. However, since UL may be used as SL, the transmission performed by communication apparatuses other than the representative communication apparatus is described as SL/UL transmission in the following. SL/UL transmission indicates SL transmission or UL transmission.

### First Embodiment

First, a first embodiment will be described. In the embodiment, a communication apparatus other than the representative communication apparatus in the group monitors the DCI (Downlink Control information, downstream control information) for the representative communication apparatus, and does not perform SL/UL transmission with the resource with which the representative communication apparatus communicates with DL or UL.

A communication apparatus other than the representative communication apparatus does not perform SL/UL transmission, for example, even if the communication apparatus receives a resource allocation for sending SL/UL from the base station 10, in the following case. That is, communication apparatus other than the representative communication apparatus does not perform SL/UL transmission when a resource to be used for performing SL/UL transmission overlaps some or all of the resources for communicating with DL or UL. For example, SL/UL transmission may performed with a resource other than the resource to be used for performing SL/UL transmission.

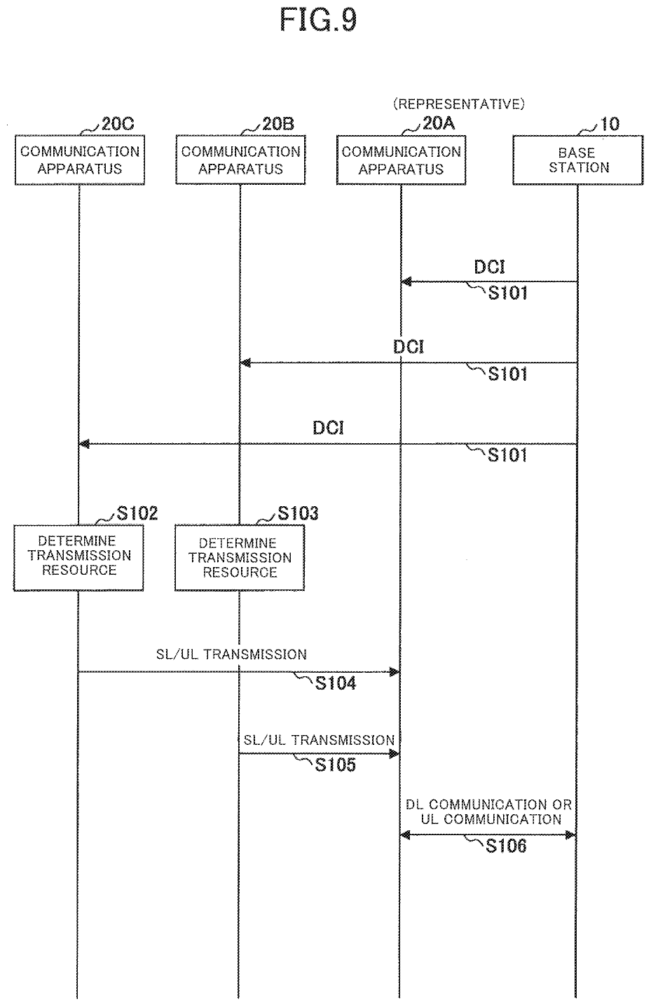

Referring to FIG. 9, an operation example of the first embodiment will be described. In the example of FIG. 9, the communication apparatus 20A, the communication apparatus 20B, and the communication apparatus 20C form one group. A representative communication apparatus is the communication apparatus 20A. Hereinafter, the communication apparatus 20A is described as “communication apparatus 20A (representative)” such that the communication apparatus 20A acts as a communication apparatus 20A that is representative.

In S101, the base station 10 transmits the DCI for the communication apparatus 20A (representative) in PDCCH (Physical Downlink Control Channel). The communication apparatus 20A (representative) receives the DCI and the communication apparatuses 20B and 20C also receive the DCI. In FIG. 9, the DCI is illustrated so that the DCI is transmitted to each of the communication apparatuses 20A to 20C at different times, for the convenience of illustration. In S101, a DCI for the communication apparatus 20A (representative) is transmitted, and the communication apparatuses 20B and 20C receive the transmitted DCI for the communication apparatus 20A (representative).

With respect to the operation of S102 to S105, the same operation is performed between the communication apparatus 20C and the communication apparatus 20B. Thus, the operation will be described with reference to the communication apparatus 20C as an example.

In S102, the communication apparatus 20C identifies the DCI received in S101 as the DCI for the communication terminal 20A (representative) and identifies the resource (the communication terminal 20A (representative) that performs UL transmission or DL reception) specified in the DCI. Such resources may be, for example, time resources (e.g., slots, sub-frames), time-frequency resources (e.g., number of resource blocks, location, etc.), or frequency resources (e.g., start position and bandwidth at frequency). The communication apparatus 20C determines a resource other than the identified resource as a resource for transmitting the SL/UL signal. Note that for example, it is assumed that the communication apparatus 20C includes transmitted data (SL or UL) in the buffer.

In S102, the communication apparatus 20C determines, for example, the transmission resource of an SL signal (e.g., SL data, SL control information, or SL data+control information) and transmits an SL signal using the determined transmission resource in the S104. S103 and S105 are similar operations.

In this example, the communication apparatus 20C performs communication using a resource other than the resource identified from the DCI for the communication terminal 20A (representative). In addition to this example, the communication apparatus 20C may execute an operation to drop (discontinue) SL/UL transmissions with an already allocated resource (or a selected resource) if some or all of with the already allocated resource (or a selected resource) for SL/UL transmissions overlap with the resources identified from the DCI for the communication terminal 20A (representative). Dropping an SL/UL transmission may also indicate that the communication apparatus 20C is not expected to transmit.

In addition, instead of dropping the SL/UL transmission with already allocated resources (or selected resources), the communication apparatus 20C may perform the SL/UL transmission by lowering the transmission power. Reducing the transmission power may be referred to as scaling the transmission power. The reduction of transmission power may also be referred to as power scaling. Further, reducing the transmission power may indicate using transmission power that is less than a predetermined threshold value, using a 1/N (N is natural number) of the transmission power used in normal SL/UL transmission, using transmission power that is obtained by subtracting a certain value from transmission power used in normal SL/UL transmission, or using other transmission power.

The SL/UL transmission may be performed with reduced transmission power instead of dropping the SL/UL transmission similarly in other embodiments.

In S106, the communication apparatus 20A (representative) performs DL or UL communication using the resources specified in the DCI received in S101. The S106 may be executed before the S105 or before the S104.

The method by which the communication apparatus 20C (or 20B) identifies the DCI for the communication apparatus 20A (representative) is not limited to a specific method; for example, the base station 10 may notify each communication apparatus within the group of the communication apparatus 20A (representative) of the individual RNTI of the communication apparatus 20A (representative). In this case, each communication apparatus in the group of the communication apparatus 20A (representative) performs a search using its own RNTI and a search using the RNTI of the communication apparatus 20A (representative).

In addition, the base station 10 may notify each communication apparatus of the group common RNTI (called Group RNTI) and transmit the DCI masked by the Group RNTI as a DCI for the communication apparatus 20A (representative). Since the DCI can be decoded in common within a group, the DCI may be referred to as a group common DCI. In this case, each communication apparatus within the group of communication apparatuses 20A (representative) performs a search using its own RNTI and a search using the RNTI of the communication apparatus 20A. (representative).

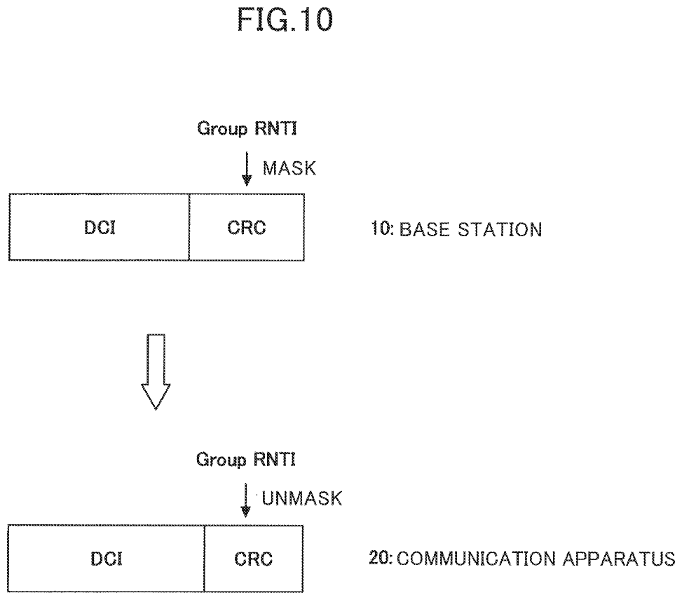

FIG. 10 illustrates an example of using Group RNTI. As illustrated in FIG. 10, the base station 10 masks the CRC of the DCI with a Group RNTI and transmits a DCI (+CRC) masked by the CRC.

The communication apparatus 20 receives a DCI (+CRC) in which CRC is masked, unmasks the CRC with the Group RNTI, and checks the CRC of the DCI. If checking of the CRC of DCI is successful, the communication apparatus 20C determines that the DCI is a DCI for the communication apparatus 20A (representative). In addition, when a predetermined information (predetermined bit value) is detected in the DCI along with the success of the CRC check, the communication apparatus 20C may determine that the DCI is a DCI for the communication apparatus 20A (representative), and perform control of the first embodiment.

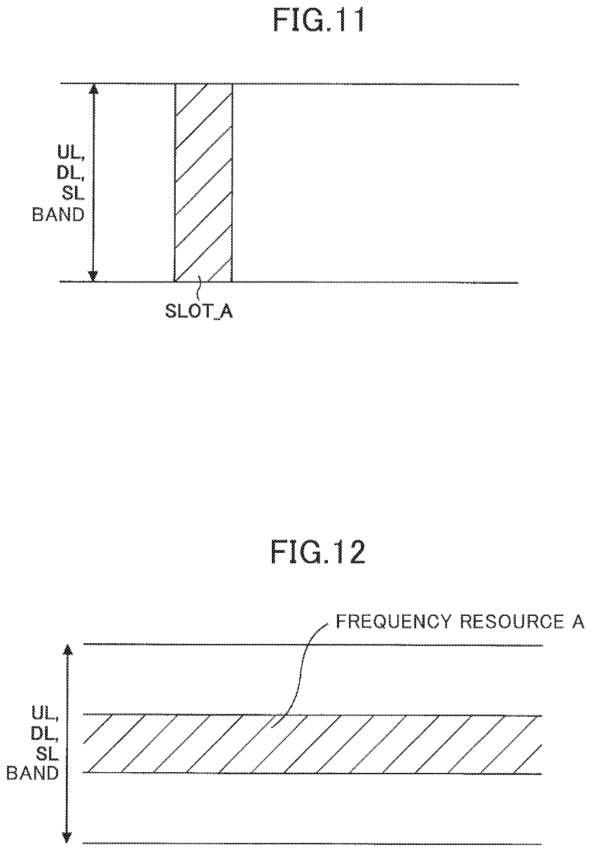

FIG. 11 illustrates an example of a resource that the communication apparatus 20C (or 20B) determines to be prohibited from using based on a DCI for the communication apparatus 20A (representative). In the example of FIG. 11, a common band (frequency band) is illustrated for UL, DL, and SL for which communication apparatus 20C (or 20B) can be used.

In the example of FIG. 11, the communication apparatus 20C (or 20B) identifies that the communication apparatus 20A (representative) uses SLOT_A to communicate UL or DL by reading the DCI for the communication apparatus 20A (representative). SLOT is an example of a time resource.

In this case, for example, the communication apparatus 20C (or 20B) does not perform SL/UL transmission using SLOT_A. More specifically, for example, when a transmission resource using SLOT_A has already been allocated to the communication apparatus 20C (or 20B), the communication apparatus 20C (or 20B) drops the transmission with the transmission resource. For example, when the communication apparatus 20C (or 20B) autonomously selects the transmit data transmission resource, the communication apparatus 20C (or 20B) selects the transmission resource from the candidate resource by excluding SLOT_A from a predetermined resource (e.g., a resource pool set from the base station 10). Candidate resources may be referred to as residual resources.

FIG. 12 illustrates another example of a resource that the communication apparatus 20C (or 20B) determines to be prohibited based on a DCI for the communication apparatus 20A (representative).

In the example of FIG. 12, the communication apparatus 20C (or 20B) identifies that the communication apparatus 20A (representative) communicates UL or DL using the frequency resource A reading the DCI for the communication apparatus 20A (representative).

In this case, for example, the communication apparatus 20C (or 20B) does not perform SL/UL transmission using frequency resource A. More specifically, for example, when a transmission resource using the frequency resource A has already been allocated to the communication apparatus 20C (or 20B), the communication apparatus 20C (or 20B) drops the transmission with the transmission resource. For example, when the communication apparatus 20C (or 20B) autonomously selects the transmission data transmission resource, the communication apparatus 20C (or 20B) selects the transmission resource from the candidate resource as the resource excluding the frequency resource A from the predetermined resource (e.g., the resource pool resource set from the base station 10).

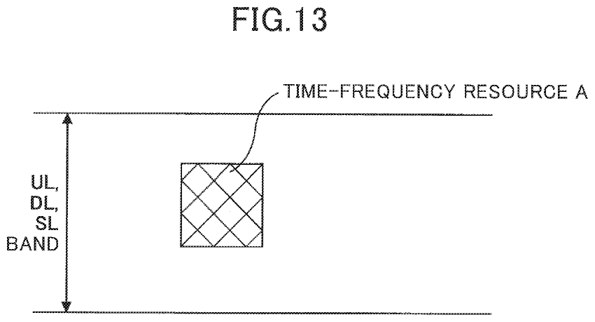

FIG. 13 illustrates still another example of a resource that the communication apparatus 20C (or 20B) determines to be prohibited (use prohibition) based on a DCI for the communication apparatus 20A (representative).

In the example of FIG. 13, the communication apparatus 20C (or 20B) identifies that the communication apparatus 20A (representative) communicates UL or DL using the time-frequency resource A by reading the DCI for the communication apparatus 20A (representative).

In this case, for example, the communication apparatus 20C (or 20B) does not perform SL/UL transmission using time-frequency resource A. More specifically, for example, when a transmission resource (or 20B) having some or all overlapping with the time-frequency resource A has already been allocated to the communication apparatus 20C (or 20B), the communication apparatus 20C (or 20B) drops the transmission with the transmission resource. For example, when the communication apparatus 20C (or 20B) autonomously selects the transmission data transmission resource, the communication apparatus 20C (or 20B) selects the transmission resource from the candidate resource by excluding the time-frequency resource A from a predetermined resource (e.g., a resource pool set from the base station 10).

According to the first embodiment, even when the UL/DL and the SL share a frequency band, the SL can efficiently communicate without interfering with the DL/UL. Further, in the first embodiment, since the communication apparatus only needs to read the DCI for the representative communication apparatus, an increase in the overhead can be avoided.

### Second Embodiment

Next, as second embodiment be described. In the second embodiment, the representative communication apparatus notifies the communication apparatus belonging to the group of the representative communication apparatus of the resources that can be used for sending SL/UL (or prohibits use in sending SL/UL). The representative communication apparatus may make the notification by broadcast (e.g., using SLSS or PSBCH) or by using individual control information (using PSSCCH) or individual data (using PSSCH) for each communication apparatus. The representative communication apparatus may use UL transmission to give the notification. For example, PRACH, PUSCH, or PUCCH are used for such UL transmissions. In the case where PUCCH is used, SR (scheduling request) may be used for the above-mentioned notification.

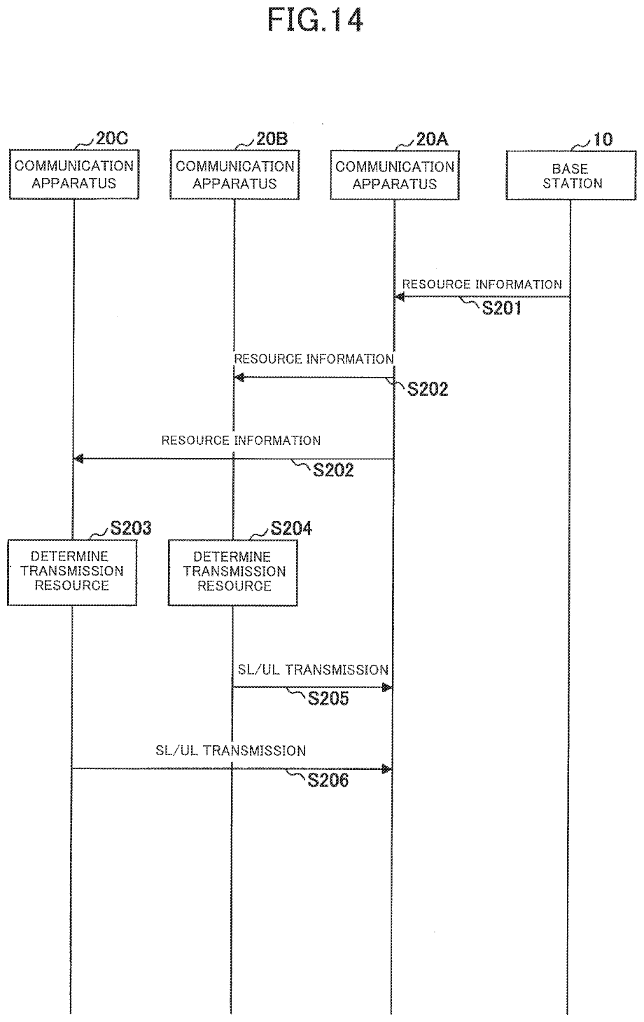

An example of operation of the second embodiment will be described with reference to FIG. 14. In the example of FIG. 14, as in FIG. 9, the communication apparatus 20A, the communication apparatus 20B, and the communication apparatus 20C form a group. A representative communication apparatus is the communication apparatus 20A. FIG. 14 also illustrates an example (i.e., an in-converge example) in which the communication apparatus 20A (representative) is located in a cell of the base station 10.

In S201, the base station 10 transmits resource information (or resource information representing a transmission resource prohibiting the use of the communication apparatuses 20B and 20C) representing the transmission resources available to the communication apparatuses 20B and 20C belonging to the group of communication apparatuses 20A (representatives), and the communication apparatus 20A receives the resource information. Such resource information may be transmitted by RRC, MAC or DCI. Note that notification of resource information in S201 may not be performed.

In S202, the communication apparatus 20A (representative) transmits the allowed transmission resource information (or the prohibited transmission resource information indicating the transmission resource prohibiting the use of the communication apparatuses 20B and 20C) representing the transmission resource usable by the communication apparatuses 20B and 20C belonging to the group of the communication apparatuses 20A (representative), and the communication apparatuses 20B and 20C receive the resource information.

As described above, the transmission of resource information in S202 may be performed in SL or may be performed in UL. In addition, the resource information transmitted from the communication apparatus 20A (representative) in the S202 may be the same as or different from the resource information received from the base station 10 in the S201. In addition, when the S201 is not implemented, the communication apparatus 20A (representative) autonomously determines the transmission resource to be used or the transmission resource to be used prohibited to the communication apparatuses 20B and 20C, and transmits the resource information representing the determined transmission resource in the S202.

In the case where the communication apparatus 20A (representative) autonomously determines the transmission resources to be used or prohibited to be used for the communication apparatus 20B and 20C, for example, the communication apparatus 20A (representative) may determine the resources to be used for the communication of the DL or UL as the transmission resources to be used as the transmission resources to be prohibited and determine the transmission resources to be used for the other resources.

With regard to the operation of S203 to S206, the same operation is performed between the communication apparatus 20C and the communication apparatus 20B. Therefore, the operation will be described with reference to the communication apparatus 20C as an example.

In S203, the communication apparatus 20C identifies the allowed transmission resources (or the prohibited transmission resources from which SL/UL transmission is prohibited) that can be used for sending SL/UL based on the resource information received in S202. Both the allowed transmission resource and the prohibited transmission resource are, for example, time resources (e.g., slots, sub-frames), time-frequency resources (e.g., number of resource blocks, location, etc.), and frequency resources (e.g., start position and bandwidth at frequency).

The allowed transmission resources may be, for example, those illustrated as SLOT_A in FIG. 11, frequency resource A in FIG. 12, or time-frequency resource A in FIG. 13. The allowed transmission resource may also be, for example, a resource other than SLOT_A in FIG. 11, a resource other than time-frequency resource A in FIG. 12, or a resource other than time-frequency resource A in FIG. 13. The prohibited transmission resource may also be, for example, a resource illustrated as SLOT_A in FIG. 11, frequency resource A in FIG. 12, or time-frequency resource A in FIG. 13.

The communication apparatus 20C determines, for example, the resource to be used to perform SL/UL transmission from among the candidate resources, using the allowed transmission resource as the candidate resource when the allowed transmission resource is identified. In addition, when the communication apparatus 20C identifies the prohibited transmission resource, for example, it determines the resource to be used for transmitting SL/UL from among the candidate resources, using the resource excluding the prohibited transmission resource as a candidate resource from a predetermined resource (e.g., the resource pool resource set from the base station 10).

In addition, when the communication apparatus 20C knows the allowed transmission resource, for example, and when a resource other than the allowed transmission resource has already been allocated as a transmission resource of SL/UL, the communication apparatus 20C drops the transmission with the transmission resource of the SL/UL. In addition, when the communication apparatus 20C is aware of the prohibited transmission resource, for example, if a resource that overlaps the prohibited transmission resource in part or in whole with the prohibited transmission resource has already been allocated as a transmission resource of the SL/UL, the communication apparatus 20C drops the transmission with the transmission resource of the SL/UL.

In the example of FIG. 14, in S203, the communication apparatus 20C determines a transmission resource for, for example, an SL signal (e.g., SL data, SL control information, or SL data+control information) and transmits it using the transmission resource in S206. S204 and S205 are similar operations.

In some cases, UL grants (i.e., UL transmitting resources) are pre-configured (configured) by the RRC in the communication apparatuses 20A-20C of the group and may be able to transmit UL without receiving a DCI UL grant. In this case, when UL data is generated, each of the communication apparatuses 20A to 20C performs UL data transmission using a predetermined resource (e.g., a predetermined time-frequency resource at a certain period) such as an RRC. “UL Grant-Free Transmission” refers to the transmission of UL data using pre-configured resources such as RRC.

In the control of the second embodiment in this case, for example, in S202 of FIG. 14, the communication apparatus 20A (representative) transmits a signal to the communication apparatuses 20B and 20C that allows or prohibits UL grant-free transmission.

As an example, when UL data to be transmitted occurs in the communication apparatus 20A (representative), the communication apparatus 20A (representative) transmits a signal prohibiting UL grant-free transmission to the communication apparatuses 20B and 20C. The communication apparatuses 20B and 20C that received this signal can provide UL grant-free transmission. Thereafter, for example, in communication apparatus 20A (representative), when transmission of UL data to be transmitted is completed, a signal that allows UL grant-free transmission is transmitted to communication apparatuses 20B and 20C. The communication apparatuses 20B and 20C that received this signal can provide UL grant-free transmission.

The communication apparatus 20A (representative) may also send only signals prohibiting UL grant-free transmission. In this case, for example, the communication apparatuses 20B and 20C that received this signal do not transmit UL grant-free for a predetermined period of time. Communications devices 20B and 20C may perform UL Grant-Free transmission if such period expires without receiving a signal prohibiting the re-transmission of UL Grant-Free within such period.

According to the second exemplary embodiment, even when the UL/DL and the SL share the frequency band, the SL can efficiently communicate without interfering with the DL/UL. Further, in the second embodiment, since the control can be performed between the communication apparatuses, the flexible control can be realized according to the judgment of the communication apparatus 20A (representative).

### Third Embodiment

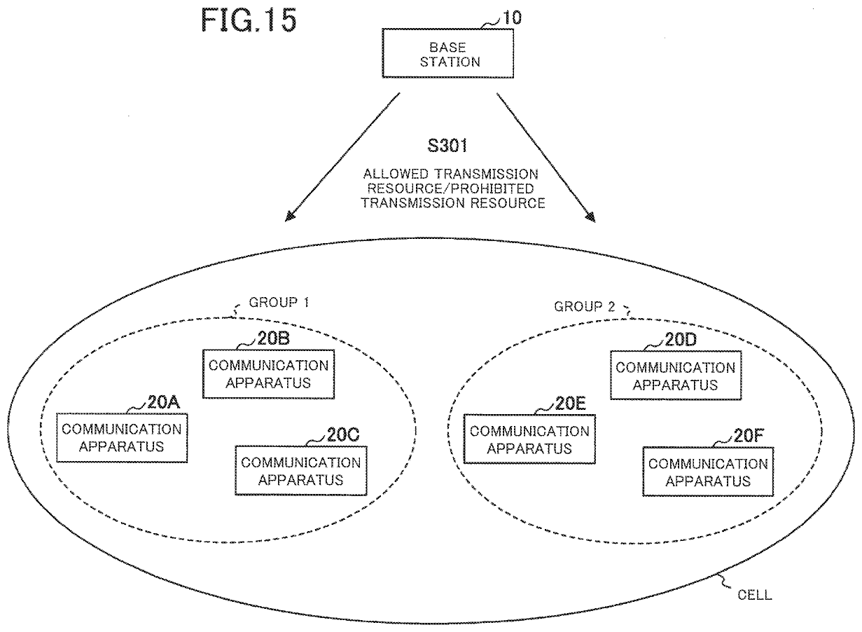

Next, a third embodiment will be described. As illustrated as S301 in FIG. 15, in the third embodiment, the base station 10 notifies the communication apparatus 20 within the coverage (in-coverage) of the base station 10 of resource information representing the transmission resource (allowed transmission resource) that can be used by the communication apparatus 20 other than the representative communication apparatus, or resource information representing the transmission resource (prohibited transmission resource) that is prohibited from being used by the communication apparatus 20 other than the representative communication apparatus.

Both the allowed transmission resource and the prohibited transmission resource are, for example, time resources (e.g., slots, sub-frames), time-frequency resources (e.g., number of resource blocks, location, etc.), or frequency resources (e.g., start position and bandwidth at frequency).

The allowed transmission resources may be, for example, those illustrated as SLOT_A in FIG. 11, frequency resource A in FIG. 12, or time-frequency resource A in FIG. 13. The allowed transmission resource may also be, for example, a resource other than SLOT_A in FIG. 11, a resource other than time-frequency resource A in FIG. 12, or a resource other than time-frequency resource A in FIG. 13. The prohibited transmission resource may also be, for example, a resource illustrated as SLOT_A in FIG. 11, frequency resource A in FIG. 12, or time-frequency resource A in FIG. 13.

For example, when the communication apparatus 20 identifies the allowed transmission resource, the communication apparatus 20 determines the resource to be used for transmitting SL/UL from among the candidate resources, using the allowed transmission resource as the candidate resource. The communication apparatus 20 determines, for example, the resource to be used for transmitting SL/UL from among the candidate resources, using the resource excluded from the predetermined resource (e.g., the resource pool resource set from the base station 10) as the candidate resource when identifying the prohibited transmission resource.

The communication apparatus 20 drops the transmission with the sending resource of the SL/UL if, for example, a resource other than the allowed transmission resource has already been allocated as the transmission resource of the SL/UL when the allowed transmission resource is identified. The communication apparatus 20 drops the transmission with the transmission resource of the SL/UL if, for example, a resource that overlaps the prohibited transmission resource in part or in whole with the prohibited transmission resource has already been allocated as the transmission resource of the SL/UL when the use prohibited transmission resource has been identified.

The notification in S301 of FIG. 15 may be made to the entire in-coverage communication apparatus 20, for example, by using broadcast information (e.g., MIB, SS/PBCH block, RMSI). In addition, the notification may be made by group or by communication apparatus by using RRC or MAC or DCI. Broadcast information, RRC, MAC, DCI, any two, any three or all of which may also be used in combination.

For example, the base station 10 notifies the downstream communication apparatus 20 of the allowed transmission resource or the prohibited transmission resource by broadcast information. The base station 10 may then use the RRC, MAC, or DCI to transmit the ON/OFF of the allowed transmission resource or prohibited transmission resource notified in the broadcast information to a specific group or to a specific communication apparatus.

In the example of FIG. 15, for example, the transmission resource or prohibited transmission resource is notified via broadcast information in S301. Thereafter, for example, the ON/OFF of the allowed transmission resource or prohibited transmission resource notified in the broadcast information is notified to each communication apparatus of group 1 using the RRC, MAC, or DCI.

The communication apparatus 20 that receives an ON performs control such as the above-described resource selection or signal drop by applying the allowed transmission resource or prohibited transmission resource received in the broadcast information. Thereafter, for example, when the communication apparatus 20 receives an OFF, the communication apparatus 20 stops the control.

In addition, when the base station 10 determines the group and the representative communication apparatus, the information representing the determined group and the representative communication apparatus may be transmitted by broadcast, for example, in the S301 of FIG. 15, along with the information of the allowed transmission resource or the prohibited transmission resource.

The control of the third embodiment may be performed alone, combined with the first embodiment, or combined with the second embodiment. In the case where the control of the third embodiment is combined with the first embodiment, for example, the base station 10 first notifies the downstream communication apparatus 20 of the allowed transmission resource or the prohibited transmission resource by the broadcast information. Thereafter, the communication apparatuses 20 of each group monitor the DCI for the representative communication apparatus. For example, the communication apparatus 20 that receives the DCI for the representative communication apparatus is allowed to perform transmission using a resource within the allowed transmission resource range if the resource identified from the DCI is a resource within the allowed transmission resource range, and the communication apparatus 20 is prohibited from performing transmission using the resource if the resource identified from the DCI is a resource exceeding the allowed transmission resource range. For example, the communication apparatus 20 that receives the DCI for the representative communication apparatus is allowed to perform transmission using a resource within the allowed transmission resource range if the resource identified from the DCI is a resource within the allowed transmission resource range, and the communication apparatus 20 is prohibited from performing transmission using the resource if the resource identified from the DCI is a resource exceeding the allowed transmission resource range.

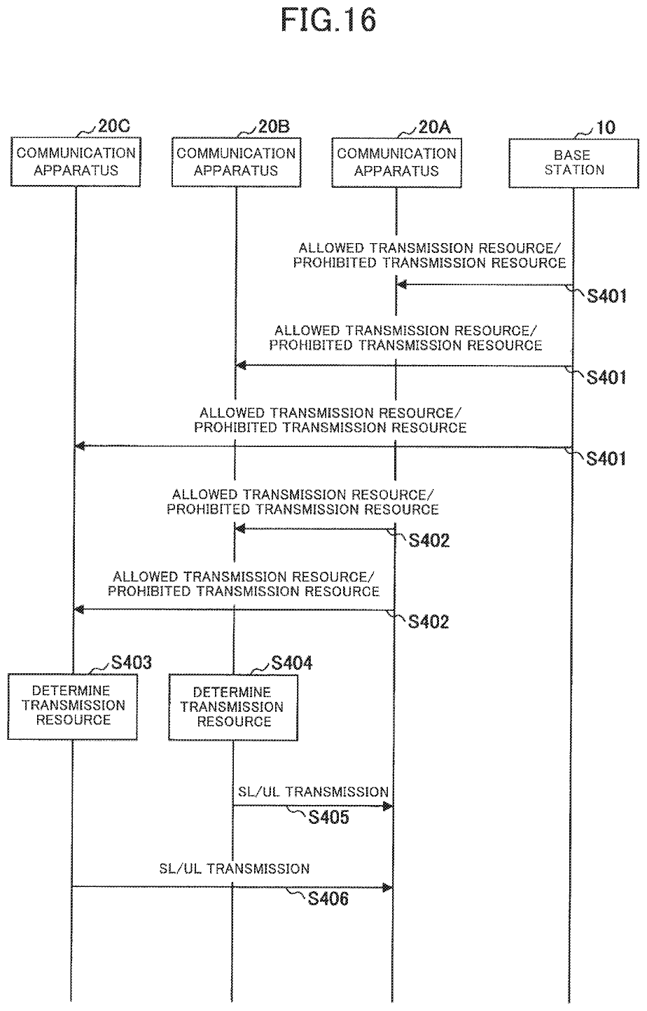

FIG. 16 is a sequence diagram illustrating an operation example when the third embodiment is combined with the second embodiment. In the example of FIG. 16, as in FIG. 9, the communication apparatus 20A, the communication apparatus 20B, and the communication apparatus 20C form a group. A representative communication apparatus is the communication apparatus 20A. FIG. 16 also illustrates an example (i.e., an in-converge example) in which the communication apparatus 20A (representative) is located in a cell of the base station 10.

S401 of FIG. 16 illustrates the operation of the third embodiment. That is, at S401, the base station 10 transmits the available transmission or prohibited transmission resources to the communication apparatuses 20C-20A, for example, by broadcast information, RRC, MAC, or DCI. The information transmitted here is, for example, notified by the communication apparatus 20, as candidates of resources, which are actually used as allowed transmission resources or prohibited transmission resources, such as {Allowed transmission resource 1, Allowed transmission resource 2, . . . Allowed transmission resource N} or {Prohibited transmission resource 1, Prohibited transmission resource 2, . . . Prohibited transmission resource N}.

In S402, for example, when the communication apparatus 20A (representative) performs communication using UL or DL resources, the communication apparatus 20A (representative) transmits information of allowed transmission resources or prohibited transmission resources that are applied to communication apparatuses 20B and 20C in the group to communication apparatuses 20B and 20C. This information may be an index that specifies any of the prohibited transmission resources (e.g., prohibited transmission resource 2) including, for example, {Allowed transmission resource 1, Allowed transmission resource 2, . . . Allowed transmission resource N} or {Prohibited transmission resource 1, Prohibited transmission resource 2, . . . Prohibited transmission resource N}. The subsequent operation is the same as S203 to S206 described in FIG. 14 of the second embodiment.

In addition to the above operations, the following operations may be performed.

First, as with the third embodiment, the base station 10 notifies the communication apparatuses 20A to 20C of the allowed transmission resources using broadcast information, RRC, MAC, or DCI. Accordingly, the communication apparatuses 20B and 20C of the group of communication apparatuses 20A (representative) can perform SL/UL transmission using the allowed transmission resources unless prohibiting instruction of prohibiting the use of the allowed transmission resources is given by the communication apparatus 20A (representative).

When communication apparatus 20A (representative) performs communication using, for example, UL or DL resources, communication apparatus 20A (representative) transmits a prohibition instruction prohibiting the use of the allowed transmission resources to communication apparatuses 20B and 20C within the group. Communications devices 20B and 20C that received the prohibition instruction do not use the allowed transmission resources. That is, for example, the communication apparatuses 20B and 20C select a resource for sending SL/UL from candidate resources that exclude the allowed transmission resource from a predetermined resource (e.g., a resource pool set from the base station 10). For example, the communication apparatuses 20B and 20C drop the SL/UL transmission when a resource, which overlaps in part or in whole with the allowed transmission resource, is allocated to SL/UL transmission.

In addition, the following operations may be performed.

First, as with the third embodiment, the base station 10 notifies the communication apparatuses 20A to 20C of the prohibited transmission resources using broadcast information, RRC, MAC, or DCI. Accordingly, the communication apparatuses 20B and 20C of the group of communication apparatuses 20A (representative) do not perform SL/UL transmission using the prohibited transmission resource unless the permission instruction for using the prohibited transmission resource is given by the communication apparatus 20A (representative).

When the communication apparatus 20A (representative) does not perform communication using, for example, UL or DL resources, the communication apparatus 20A (representative) transmits an permission instruction to the communication apparatuses 20B and 20C in the group to allow use of the prohibited transmission resource. The communication apparatuses 20B and 20C that received the permission-to-use instruction may perform SL/UL transmission using the prohibited transmission resource.

According to the third embodiment, even when the UL/DL and the SL share a frequency band, the SL can efficiently communicate without interfering with the DL/UL. Further, in the third embodiment, since the base station 10 can notify the allowed transmission resource/prohibited transmission resource, flexible control can be performed according to the determination of the base station 10. In addition, a wide range of available transmission and prohibited transmission resources can be notified within the coverage, allowing efficient control.

### Fourth Embodiment

Next, a fourth embodiment will be described. The fourth embodiment is applicable to any of first to third embodiments and fifth embodiment. In the fourth embodiment, an example of a method for determining a group and a representative communication apparatus will be described.

The communication apparatus 20 may be located within the coverage (in-coverage) of the base station 10 or outside the coverage (out-of-coverage) of the base station 10. Since the representative communication apparatus is basically a communication apparatus that transmits data to the base station 10 or receives data from the base station 10, the communication apparatus determined as the representative communication apparatus may be limited to the in-coverage communication apparatus 20. However, the representative communication apparatus is not limited to the in-coverage communication apparatus 20, and the out-of-coverage communication apparatus 20 may be a representative communication apparatus.

Further, one representative communication apparatus may be present in a group or multiple representative communication apparatuses may be present.

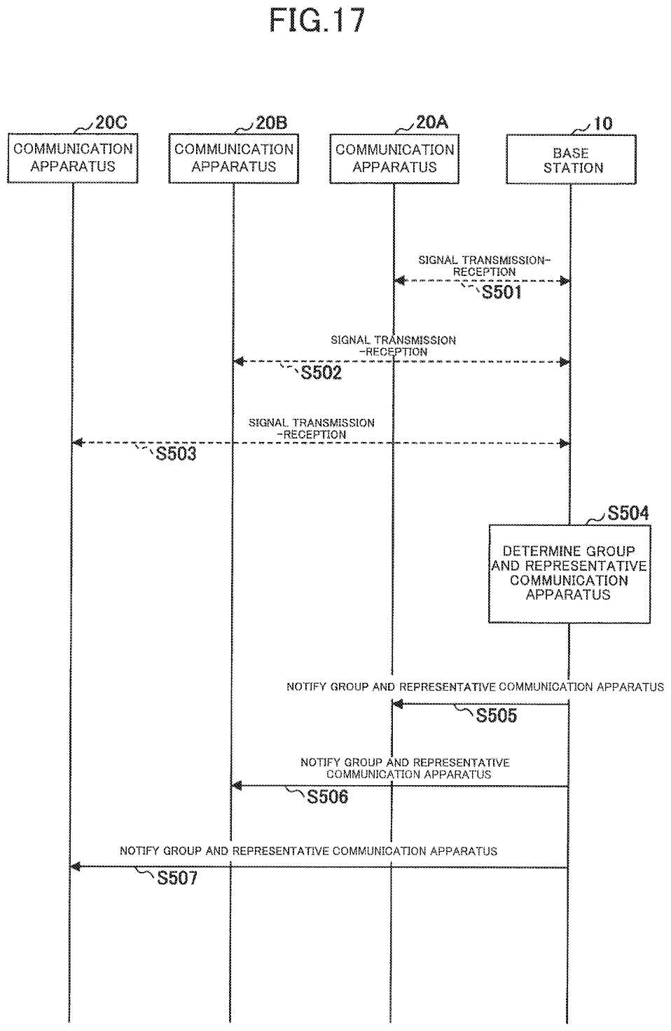

Referring to FIG. 17, a first operational example for determining a group and a representative communication apparatus will be described. In FIG. 17, it is assumed that the communication apparatuses 20A to 20C become groups.

In S501 to S503, the base station 10 transmits or receives a signal with each communication apparatus 20 to identify the received power (RSRP) or the received quality (RSRQ, SINR) or the received strength (RSSI) of each communication apparatus 20. Some or all of the received power (RSRP) or received quality (RSRQ, SINR) or received strength (RSSI) may be identified. Since the received power, the received quality, and the received strength are all values related to the quality, the received power, the received quality, and the received strength may be collectively referred to as the “quality value.”

For example, the base station 10 receives the received power (RSRP), the received quality (RSRQ, SINR), or the received strength (RSSI) measured by receiving the DL signal or receiving the SL signal in each of the communication apparatuses 20A to 20C from each of the communication apparatuses 20A to 20C, thereby identifying the received power (RSRP), the received quality (RSRQ, SINR), or the received strength (RSSI) at each at the communication apparatuses 20A to 20C.

In addition, the base station 10 may identify the received power (RSRP), the received quality (RSRQ, SINR), or the received strength (RSSI) of each of the communication apparatuses 20A to 20C by receiving the UL signal or the SL signal transmitted from each of the communication apparatuses 20A to 20C.

In S504, the base station 10 determines the group and the representative communication apparatus in the group based on the quality value obtained as described above.

For example, the base station 10 determines a plurality of communication apparatuses 20 having a quality value within a certain range of values as one group, and determines the communication apparatus 20 having the best quality value among the plurality of communication apparatuses 20 in the group (e.g., the communication apparatus having the greatest received power of DL or UL) as the representative communication apparatus.

In the example of FIG. 17, it is assumed that the communication apparatuses 20A to 20C are determined as one group and the communication apparatus 20A is determined as a representative communication apparatus. In this case, for example, the base station 10 notifies the communication apparatuses 20A to 20C of information indicating that the communication apparatuses 20A to 20C belong to one group and information indicating that the communication apparatus 20A is a representative communication apparatus of the group (S505 to S507). Notifications in S505 to S507 may be made by broadcast or may be made individually to the communication apparatus by RRC, MAC or DCI. Group RNTI may be included in the notice of S505 to S507. In addition, the notifications S505 to S507 may inform the allowed transmission resource or prohibited transmission resource described in the third embodiment.

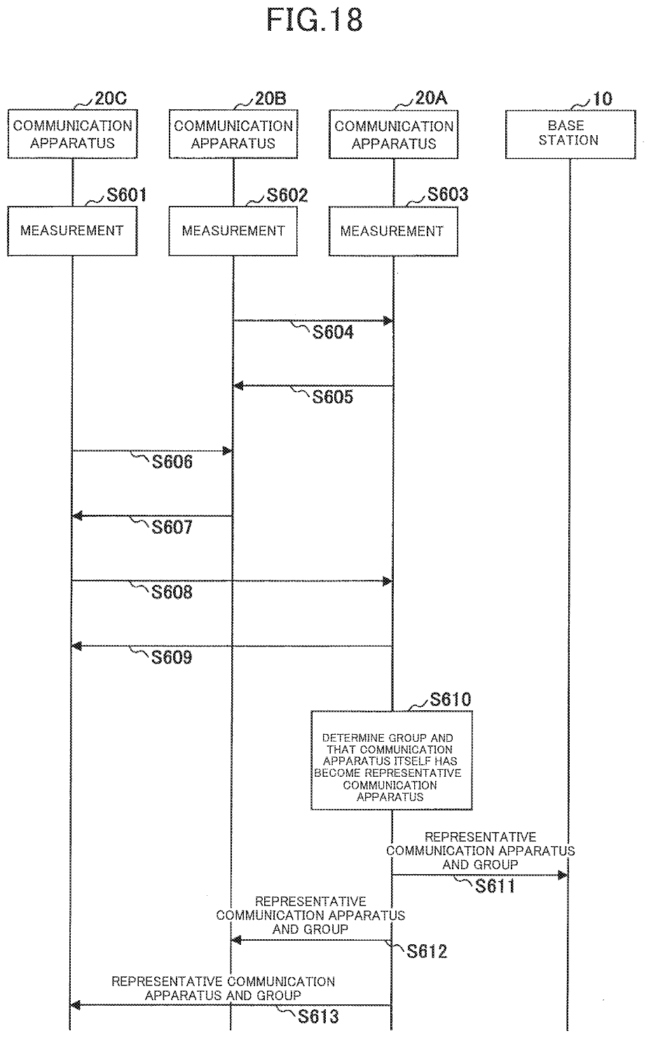

Referring to FIG. 18, a second operational example for determining a group and a representative communication apparatus will be described. In FIG. 18, it is also assumed that the communication apparatuses 20A to 20C become groups. In the second operational example, each communication apparatus 20 performs operations for determining a group and a representative communication apparatus.

In S601 to S603 of FIG. 18, each communication apparatus 20 receives a signal transmitted from each communication apparatus 20, and each communication apparatus 20 identifies the received power (RSRP) or the received quality (RSRQ, SINR) or the received strength (RSSI) of each other communication apparatus 20. For measurement, a UL signal transmitted from each communication apparatus 20 may be used, or an SL signal may be used. Further, each communication apparatus 20 identifies the received power (RSRP) or the received quality (RSRQ, SINR) or the received strength (RSSI) by the DL signal from the base station 10. Each communication apparatus 20 may receive received power (RSRP) or received quality (RSRQ, SINR) or received strength (RSSI) measured by the received UL signal at the base station 10 from the base station 10. Some or all of the received power (RSRP) or received quality (RSRQ, SINR) or received strength (RSSI) may be identified.

The received power, received quality, and received strength measured between communication apparatuses are collectively referred to as “SL quality values”. Further, the received power, reception quality, and reception strength measured between the base stations 10 are collectively referred to as “UL/DL quality values”.

As illustrated in S604 to S609 of FIG. 18, each communication apparatus 20 notifies another communication apparatus of the SL quality value and UL/DL quality value that the communication apparatus 20 itself has measured. Accordingly, each communication apparatus can identify the SL quality value between the communication apparatus and other communication apparatuses identified by each of the other communication apparatuses and the UL/DL quality value identified by each of the other communication apparatuses.

Each communication apparatus 20 determines, for example, whether the UL/DL quality value of the corresponding communication apparatus 20 is the best (e.g., the maximum receiving power) among the UL/DL quality values of the communication apparatuses that can be identified, and if UL/DL quality value of the corresponding communication apparatus 20 is best, the communication apparatus 20 determines that the communication apparatus 20 itself acts as a representative communication apparatus. In the example of FIG. 18, the communication apparatus 20A has determined to become a representative communication apparatus.

The representative communication apparatus 20A, for example, determines that a communication apparatus whose SL quality value with the communication apparatus 20A is higher than a predetermined threshold belongs to its own group. In this case, it is determined that the communication apparatuses 20B and 20C belong to the group of the communication apparatuses 20A.

In this case, the communication apparatus 20A (representative) notifies the base station 10 and the communication apparatuses 20B and 20C of information indicating that the communication apparatuses 20A to 20C belong to one group and information indicating that the communication apparatus 20A is a representative communication apparatus of the group (S611 to S613). The notification (S611) to the base station 10 may not be made.

According to the fourth embodiment, a group and a representative communication apparatus can be appropriately determined.

### Fifth Embodiment

Next, a fifth embodiment will be described. The fifth embodiment is applicable to any of the embodiments or first to fourth embodiments. In fifth embodiment, the communication apparatus 20 switches operation depending on whether the communication apparatus 20 is in-coverage or out-of-coverage.

As an example, when the communication apparatus 20 determines that the communication apparatus 20 is in-converge, the communication apparatus 20 performs the operation of the third embodiment. That is, when the communication apparatus 20 determines that the communication apparatus 20 is in-coverage, the communication apparatus 20 performs an operation using an allowed transmission resource or a prohibited transmission resource received from the base station 10. In addition, the communication apparatus 20 may perform the operation of the first embodiment when the communication apparatus 20 determines that the communication apparatus 20 is in-converge.

In addition, the communication apparatus 20 may perform the operation of the second embodiment when the communication apparatus 20 determines that the communication apparatus 20 is out-of-converge. In this case, when the communication apparatus 20 itself is not a representative communication apparatus, the communication apparatus 20 expects information of the allowed transmission resource or the prohibited transmission resource from the representative communication apparatus. When the communication apparatus 20 determines that the communication apparatus 20 is in the Out-of-coverage, when the communication apparatus 20 itself is a representative communication apparatus, the communication apparatus 20 transmits information of the transmission resource available or the transmission resource prohibited from being used as the operation of the second exemplary embodiment.

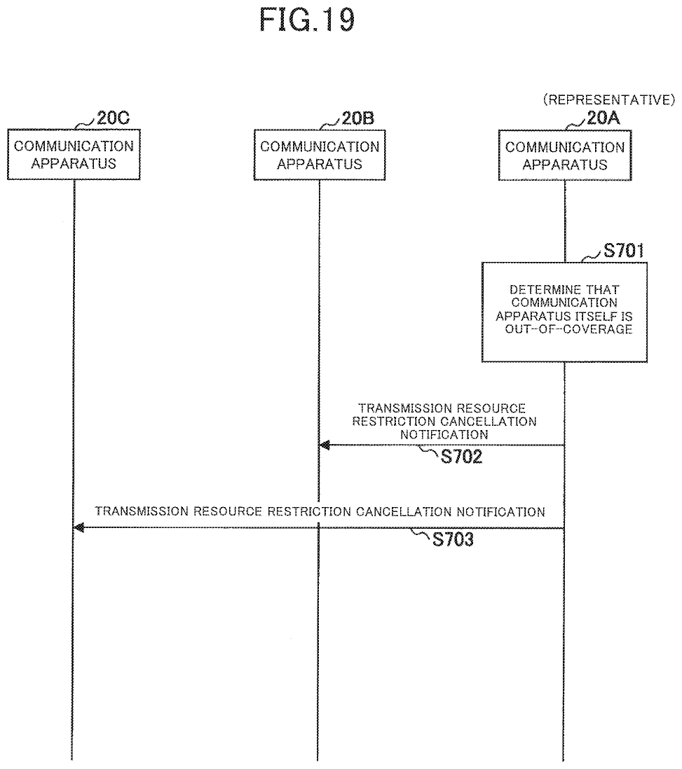

In addition, the control illustrated in FIG. 19 may be implemented. The control illustrated in FIG. 19 can be applied to any of the first to fourth embodiments. FIG. 19 illustrates a case where the communication apparatus 20A to 20C belongs to a group and the communication apparatus 20A is a representative communication apparatus. Further, at a point prior to the S701 of FIG. 19, the communication apparatus 20A is in-converge, and the transmission resource restriction for the communication apparatuses 20B and 20C is limited by any of first to third embodiments.

In S701 of FIG. 19, the communication apparatus 20A (representative) determines that the communication apparatus 20A has itself turned out to be Out-of-coverage. Then, in S702 and S703, the communication apparatus 20A transmits the transmission resource restriction cancellation notification to the communication apparatuses 20B and 20C. The communication apparatuses 20B and 20C that received the transmission resource restriction cancellation notification stop the control of the transmission resource restriction described in first to third embodiments. That is, according to the first example, even when the communication apparatuses 20B and 20C receive a DCI for the communication apparatus 20A (representative) after the S702 and S703, the communication apparatuses 20B and 20C can perform SL/UL transmission using the resources identified from the DCI.

In addition to the control illustrated in FIG. 19, when the communication apparatus 20B (or 20C) determines that the communication apparatus 20B (or 20C) itself has turned out to be Out-of-coverage, the communication apparatus 20A (representative) may also be presumed to have become Out-of-coverage, and the transmission resource restriction may be canceled.

The operation of cancelling the transmission resource restriction based on the Out-of-coverage detection described above may be performed when the communication apparatus 20 detects Out-of-coverage and the quality value of the signal from the communication apparatus 20 outside its own group is equal to or less than a predetermined threshold value. In order to avoid excessive interference with the communication apparatus 20 outside the group.

The communication apparatus 20 can determine the determination of the Out-of-coverage based on one or more of RSRP (CSI-RSRP, SSS-RSRP, SRSS-RSRP), RSRQ (CSI-RSRQ, SS-RSRQ), SINR (CSI-SINR, SS-SINR), or RSSI. As an example, the communication apparatus 20 measures the CSI-RSRP by receiving the CSI-RS from the base station 10, and when the value of the CSI-RSRP is below a predetermined threshold value, the communication apparatus 20 determines that the communication apparatus 20 itself is the Out-of-coverage of the base station 10 transmitting the CSI-RS.

For the communication apparatus 20 to perform the determination of Out-of-coverage based on quality values such as RSRP (CSI-RSRP, SSS-RSRP, SRSS-RSRP), RSRQ (CSI-RSRQ, SS-RSRQ), SINR (CSI-SINR, SS-SINR), and RSSI may only be one example. For example, the communication apparatus 20 may determine whether or not the communication apparatus 20 itself has become Out-of-coverage based on information (e.g., position information) obtained from a sensor (e.g., a GPS device) provided by the communication apparatus 20. For example, the communication apparatus 20 may determine whether or not another communication apparatus (e.g., a representative communication apparatus) has become an Out-of-coverage based on information (e.g., image information) obtained from a sensor (e.g., a camera) provided by the communication apparatus 20.

According to fifth embodiment, efficient operation according to Out-of-coverage or In-coverage can be achieved.

### Apparatus Configuration

Next, a functional configuration example of the base station 10 and the communication apparatus 20 that execute the process operation described so far will be described. The base station 10 and the communication apparatus may comprise all of the functions of first to fifth embodiments described in this embodiment, or may comprise only some of the functions of first to fifth embodiments.

### Base Station 10

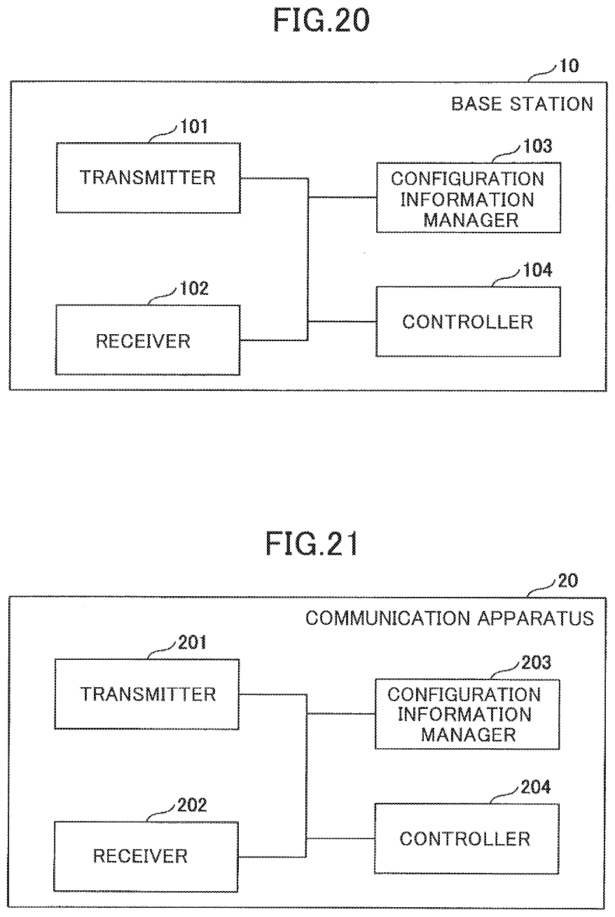

FIG. 20 is a diagram illustrating an example of a functional configuration of a base station 10. As illustrated in FIG. 20, the base station 10 includes a transmitter 101, a receiver 102, a configuration information management unit 103, and a controller 104. The functional configuration illustrated in FIG. 20 is only one example. If the operation according to the present embodiment can be executed, the name of the functional classification and the functional portion may be any one. The transmitter 101 is referred to as a transmitter, and the receiver 102 may be referred to as a receiver.

The transmitter 101 includes a function of generating a signal to be transmitted to the communication apparatus 20 and transmitting the signal wirelessly. The receiver 102 includes a function for receiving various signals transmitted from the communication apparatus 20 and acquiring information of a higher layer, for example, from the received signal. The receiver 102 includes a function for measuring the received signal and acquiring a quality value.

The configuration information management unit 103 stores the preset configuration information, the configuration information received from the communication apparatus 20, and the like. The configuration information related to the transmission may be stored in the transmitter 101, and the configuration information related to the reception may be stored in the receiver 102. The controller 104 controls the base station 10. The function of the controller 104 related to the transmission is included in the transmitter 101, and the function of the controller 104 related to the reception may be included in the receiver 102.

For example, in response to the operation of the third embodiment, the controller 104 creates an allowed resource information representing a resource allowed to be used for transmission, or a prohibited resource information representing a resource prohibited to be used for transmission, and transmits the created information by the transmitter 101. In addition, in accordance with the operation of the first embodiment, the transmitter 101 creates a DCI and transmits the DCI.

The controller 104 determines the group and the representative communication apparatus in the manner described in FIG. 17 of the fourth embodiment, and the transmitter 101 transmits information representing the group and the representative communication apparatus.

### Communication Apparatus 20

FIG. 21 is a diagram illustrating an example or a functional configuration of a communication apparatus 20. As illustrated in FIG. 21, the communication apparatus 20 includes a transmitter 201, a receiver 202, a configuration information management unit 203, and a controller 204. The functional configuration illustrated in FIG. 21 is only one example. If the operation according to the present embodiment can be executed, the name of the functional classification and the functional portion may be any one. The transmitter 201 is referred to as a transmitter, and the receiver 202 may be referred to as a receiver. The communication apparatus 20 may be a representative communication apparatus or a communication apparatus other than a representative communication apparatus.

The transmitter 201 creates a transmission from the transmission data and transmits the transmission signal wirelessly. The receiver 202 receives a variety of signals wirelessly and acquires a higher layer signal from the received physical layer signal. The receiver 202 includes a function for measuring the received signal and acquiring a quality value.

The configuration information management unit 203 stores the preset configuration information, the configuration information received from the base station 10, and the like. The configuration information related to the transmission may be stored in the transmission unit 201, and the configuration information related to the reception may be stored in the receiver 202. The controller 204 controls the communication apparatus 20. The function of the controller 204 related to the transmission is included in the transmission unit 201, and the function of the controller 204 related to the reception may be included in the receiver 202.

The controller 204 may determine a representative communication apparatus with the group in the manner described in FIG. 18 of the fourth embodiment, and the transmitter 201 may make the determined group and representative communication apparatus to communicate with the base station 10 to other communication apparatuses 20.

In addition, the controller 204 may determine the Out-of-coverage by the method described in FIG. 19 of the fifth embodiment, and when it is determined to be Out-of-coverage, the transmitter 201 may notify the cancellation of the transmission resource restriction.

For example, the receiver 202 may be configured to receive control information for a particular communication apparatus from a base station, and the transmitter 201 may be configured to identify the resources used for communication by the particular communication apparatus based on the control information, and perform a process that does not perform transmission using the resource.

The transmitter 201 may execute the process of selecting the transmission resource to be used for transmission from the resource excluding the resource as the process. The transmitter 201 may execute the process of dropping the transmission to which the resource has been allocated. The transmitter 201 may execute the transmission to which the resource has been allocated by performing power scaling.

When the receiver 202 detects specific information from the control information, the transmitter 201 may execute the processing.

The controller 204, for example, determines whether a particular communication apparatus is within the coverage of the base station or outside the coverage of the base station based on the quality value of the signal received by the receiver 202, and when it is determined by the controller 204 that the particular communication apparatus is outside the coverage of the base station, the transmitter 201 may not perform the processing.

The receiver 202 is configured to receive the allowed resource information representing the resource allowed to be used for transmission or the prohibited resource information representing the resource prohibited to be used for transmission from a specific communication apparatus, and the transmitter 201 may be configured to execute a process of performing transmission using the resource indicated in the allowed resource information or a process of not performing transmission using the resource indicated in the prohibited resource information.

In addition, the communication apparatus 20 belongs to a group, and the controller 204 is configured to generate allowed resource information indicating a resource that other communication apparatuses in the group can use for transmission based on information received from the base station or based on resources used for communication by the communication apparatus, or resource information indicating a resource prohibited from being used for transmission by the other communication apparatus. The transmitter 201 may be configured to transmit the allowed resource information or the prohibited resource information to the other communication apparatus.

In addition, the receiver 202 is configured to receive the allowed resource information indicating the resource allowed to be used for transmission or the prohibited resource information indicating the resource prohibited to be used for transmission from the base station, and the transmitter 201 may be configured to execute a process of performing transmission using the resource indicated in the allowed resource information or a process of not performing transmission using the resource indicated in the prohibited resource information.

### Hardware Configuration

The block diagram (FIGS. 20 to 21) used in the description of the above-described embodiment illustrates a block of functional units. These functional blocks (components) are implemented by any combination of hardware and/or software. Further, the means for implementing each functional block is not particularly limited. That is, each functional block may be implemented by one device with a physical and/or logical combination of elements, or two or more devices that are physically and/or logically separated may be connected directly and/or indirectly (e.g., wired and/or wireless) and implemented by a plurality of these devices.

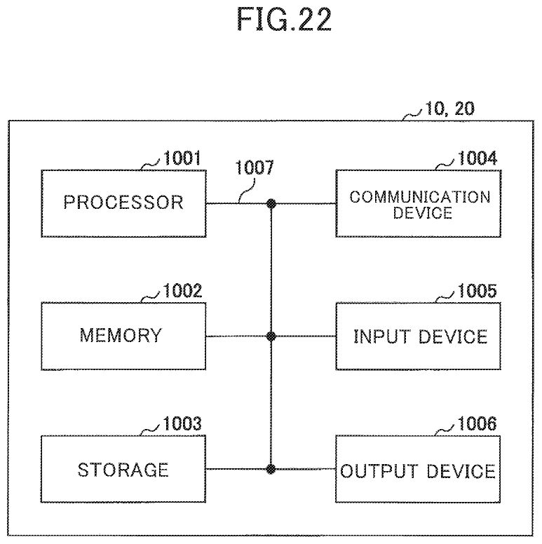

For example, any of the communication apparatus 20 and the base station 10 according to an embodiment of the present invention may function as a computer performing processing according to the present embodiment. FIG. 22 is a diagram illustrating an example of a hardware configuration of a communication apparatus 20 and a base station 10 according to the present embodiment. Each of the aforementioned communication apparatuses 20 and base stations 10 may be physically configured as a computer device including a processor 1001, a memory 1002, a storage 1003, a communication device 1004, an input device 1005, an output device 1006, a bus 1007, and the like.

In the following description, the term “device” can be read as a circuit, device, unit, etc. The hardware configuration of the base station 10 and the communication apparatus 20 may be configured to include one or more of the respective devices illustrated with reference to 1001 to 1006 in the figure or may be configured without including some of the devices.

The functions of the communication apparatus 20 and the base station 10 are implemented by allowing predetermined software (programs) to be loaded on the hardware such as the processor 1001, the memory 1002, and the like, so as to cause the processor 1001 to perform calculations to control communications by the communication device 1004, and reading and/or writing of data in the memory 1002 and the storage 1003.

A processor 1001, for example, operates an operating system to control the entire computer. The processor 1001 may be configured to include a central processing unit (CPU) having an interface with peripherals, a control device, an operation device, and registers.

In addition, the processor 1001 loads programs (program codes), software modules or data from the storage 1003 and/or the communication device 1004 into the memory 1002, and executes various processes according to the loaded programs, software modules or data. As a program, a program that causes a computer to execute at least a portion of the operation described in the above-described embodiment is used. For example, the transmitter 101, the receiver 102, the configuration information management unit 103, and the controller 104 of the base station 10 illustrated in FIG. 20 may be implemented by a control program stored in the memory 1002 and operated by the processor 1001. The transmitter 201 of the communication apparatus 20 illustrated in FIG. 21, the receiver 202, the configuration information management unit 203, and the controller 204 may be implemented by a control program stored in the memory 1002 and operated by the processor 1001. Although the various processes described above have been described as being executed in one processor 1001, they may be executed simultaneously or sequentially by two or more processors 1001. The processor 1001 may be implemented in one or more chips. The program may be transmitted from the network via a telecommunications line.

The memory 1002 may be a computer-readable recording medium composed of at least one of a ROM (Read Only Memory), an EPROM (Erasable Programmable ROM), an EEPROM (Electrically Erasable Programmable RON), a RAM (Random Access Memory) and the like. The memory 1002 may be referred to as a register, a cache, a main memory (main storage device), etc. The memory 1002 may store executable programs (program codes), software modules, and the like for implementing a process according to the embodiment of the present invention.

The storage 1003 is a computer-readable recording medium composed, for example, of at least one of an optical disk such as a CD-RCM (Compact Disk ROM), a hard disk drive, a flexible disk, a magneto-optical disk (e.g., a compact disk, a digital versatile disk, and a Blu-ray (registered trademark) disk), a smart card, a flash memory (e.g., a card, a stick, and a key drive), a floppy (registered trademark) disk, and a magnetic strip. The storage 1003 may be referred to as an auxiliary storage device. The above-described storage medium may be, for example, a database including the memory 1002 and/or the storage 1003, a server, or any other suitable medium.

The communication device 1004 is a hardware (transceiver device) for communicating between computers over a wired and/or wireless network, and is also referred to, for example, as a network device, a network controller, a network card, a communication module, and the like. For example, the transmitter 201 and the receiver 202 of the communication apparatus 20 may be implemented in the communication device 1004. The transmitter 101 and the receiver 102 of the base station 10 may be implemented in the communication device 1004.

The input device 1005 is an input device (e.g., a keyboard, a mouse, a microphone, a switch, a button, a sensor, etc.) that receives an external input. The output device 1006 is an output device (e.g., a display, speaker, LED lamp, etc.) that performs outgoing output. The input device 1005 and the output device 1006 may be of an integrated configuration (e.g., a touch panel). The input device 1005 and the output device 1006 may be of an integrated configuration (e.g., a touch panel).

Each device, such as processor 1001 and memory 1002, is also connected by a bus 1007 for communicating information. The bus 1007 may be comprised of a single bus or may be comprised of different buses between devices.

In addition, the communication apparatus 20 and the base station 10 may each include hardware such as a microprocessor, a digital signal processor (DSP), an ASIC (Application Specific Integrated Circuit), a PLD (Programmable Logic Device), and a FPGA (Field Programmable Gate Array), wherein the hardware may implement some or all of the functional blocks. For example, processor 1001 may be implemented in at least one of the hardware.

### Summary of Embodiments

This specification discloses at least the following communication apparatuses.

### Clause 1

A communication apparatus comprising:

a receiver configured to receive control information for a specified communication apparatus from a base station; and

a transmitter configured to identify, based on the control information, a resource used by the specified communication apparatus for communication, and to execute a process of not performing transmission using the identified resources.

The above configuration provides a technique for avoiding SL/UL transmission by one communication apparatus from interfering with communication between a specific communication apparatus and a base station.

### Clause 2

The communication apparatus according to Clause 1, wherein

the transmitter executes, as the process, a process of selecting a transmission resource used for transmission from resources excluding the identified resource.

The above configuration enables use of a candidate resource for SL/UL transmission, for example, to avoid interfering with communication between a specific communication apparatus and a base station.

### Clause 3

The communication apparatus according to Clause 1 or 2, wherein

the transmitter executes, as the process, a process of dropping of transmission to which the identified resource has been allocated.

The above configuration efficiently avoids interfering with communication between a specific communication apparatus and a base station.

### Clause 4

The communication apparatus according to any one of Clauses 1 to 3, wherein

the transmitter executes the process, in response to the receiver detecting specific information from the control information.

The above configuration may restrict the implementation of control to avoid interfering with communication between a specific communication apparatus and a base station, for example, only if required.

### Clause 5

The communication apparatus according to any one of Clauses 1 to 4, further comprising:

a controller configured to determine whether the specific communication apparatus is within coverage of the base station or is outside the coverage of the base station, wherein

the transmitter does not perform the process, in response to the controller determining that the specific communication apparatus is outside the coverage of the base station.

The above configuration allows the communication apparatus to transmit without limitation of transmission resources when a specific communication apparatus is outside of coverage.

### Clause 6

A communication apparatus comprising:

a receiver configured to receive allowed resource information indicating a resource that is allowed to be used for transmission or prohibited resource information indicating a resource that is prohibited to be used for transmission from a specific communication apparatus; and

a transmitter configured to execute a process of performing transmission using the resource indicated in the allowed resource information or a process of not performing transmission using the resource indicated in the prohibited resource information.

The above configuration provides a technique for avoiding SL/UL transmission by one communication apparatus from interfering with communication between a specific communication apparatus and a base station.

### Clause 7

A communication apparatus belonging to a group, the communication apparatus comprising:

a controller configured to generate allowed resource information or prohibited resource information, based on information received from the base station, or based on a resource used by the communication apparatus for communication, the allowed resource information indicating a resource allowed for another communication apparatus in the group to use for transmission, and the prohibited resource information indicating a resource prohibited from being used by the other communication apparatus for transmission; and

a transmitter configured to transmit the allowed resource information or the prohibited resource information to the other communication apparatus.

The above configuration provides a technique for avoiding SL/UL transmission by one communication apparatus from interfering with communication between a specific communication apparatus and a base station.

### Clause 8

A communication apparatus comprising:

a receiver configured to receive allowed resource information indicating a resource that is allowed to be used for transmission or prohibited resource information indicating a resource that is prohibited to be used for transmission from a base station; and

a transmitter configured to execute a process of performing transmission using the resource indicated in the allowed resource information or a process of not performing transmission using the resource indicated in the prohibited resource information.

The above configuration provides a technique for avoiding SL/UL transmission by one communication apparatus from interfering with communication between a specific communication apparatus and a base station.

### Supplementary Description of Embodiments

While embodiments of the present invention have been described above, the disclosed invention is not limited to such embodiments, and those skilled in the art will understand various modifications, modifications, alternatives, substitutions, and the like. Descriptions have been made using specific numerical examples to facilitate understanding of the invention, but, unless otherwise indicated, these values are merely examples and any suitable value may be used. In the above description, partitioning of items is not essential to the present invention. Matters described in two or more items may be combined if necessary. Matters described in one item may be applied to matters described in another item (as long as they do not conflict). The boundaries of functional parts or processing parts in the functional block diagram do not necessarily correspond to the boundaries of physical parts. Operations of multiple functional units may be physically performed in a single part, or operations of a single functional unit may be physically performed by multiple parts. The order of steps in the above described operating procedures according to an embodiment may be changed as long as there is no contradiction. For the sake of convenience, the communication apparatus 20 and the base station 20 have been described by using functional block diagrams. These apparatuses may be implemented by hardware, by software, or by combination of both. The software which is executed by a processor included in the communication apparatus 20 according to an embodiment and the software which is executed by a processor included in the base station 10 may be stored in a random access memory (RAM), a flash memory, a read-only memory (ROM), an EPROM, an EEPROM, a register, a hard disk drive (HDD), a removable disk, a CD-ROM, a database, a server, or any other appropriate recording medium.

Notification of information is not limited to the embodiments/embodiments described herein, but may be performed in other ways. For example, reporting of information may be performed by physical layer signaling (e.g., DCI (Downlink Control Information), UCI (Uplink Control Information)), upper layer signaling (e.g., RRC (Radio Resource Control) signaling, MAC (Medium Access Control) signaling, broadcast information (MIB (Master Information Block) and SIB (System Information Block)), and other signals or a combination thereof. Further, RRC signaling may be referred to as an RRC message, and may be an RRC connection setup (RRCC connection setup) message, an RRC connection reconfiguration (RRCC connection registration) message, or the like.

Each aspect/embodiment described herein may be applied to LTE (Long Term Evolution), LTE-A (LTE-Advanced), SUPER 3G, IMT-Advanced, 4G, 5G, NR, FRA (Future Radio Access), W-CDMA (registered trademark), GSM (registered trademark), CDMA 2000, UMB (Ultra Mobile Broadband), IEEE 802.11 (Wi-Fi), IEEE 802.16 (WiMAX), IEEE 802.20, UWB (Ultra-Wide Band), Bluetooth (registered trademark), and a system that utilize other suitable systems and/or a next generation system expanded based on such a system.

The order of processes, sequences, flowcharts, etc. of each aspect/embodiment described in the present specification may be exchanged as long as there is no inconsistency. For example, for the methods described in the specification, the elements of the various steps are presented in an exemplary order and are not limited to a specific order presented.

The particular operation described herein to be performed by base station 10 may be performed by an upper node in some cases. It is apparent that in a network consisting of one or more network nodes having base stations 10, various operations performed for communication with communication apparatuses 20 may be performed by base stations 10 and/or other network nodes other than base stations 10 (e.g., but not limited to MME or S-GW) . As illustrated above, other network nodes other than base station 10 may be a combination of multiple other network nodes (e.g., MME and S-GW).

Each of the embodiments/embodiments described herein may be used alone, in combination, or switched upon implementation.

The communication apparatus 20 may be referred to, by a person ordinarily skilled in the art, as a subscriber station, a mobile unit, a subscriber unit, a wireless unit, a remote unit, a mobile device, a wireless device, a wireless communication apparatus, a remote device, a mobile subscriber stations, an access terminal, a mobile terminal, a wireless terminal, a remote terminal, a handset, a user agent, a mobile client, a client, or it may also be called by some other suitable terms.

The base station 10 may also be referred to, by those skilled in the art, as NB (Node B), eNB (enhanced Node B), Base Station, gNB, or several other suitable terms.

As used herein, the terms “determining” and “deciding” may encompass a wide variety of actions. The terms “determining” and “deciding” may be deemed to include, for example, judging, calculating, computing, processing, deriving, investigating, looking up (e.g., searching tables, databases or other data structures), and ascertaining. Further, the terms “determining” and “deciding” may be deemed to include, for example, receiving (e.g., receiving information), transmitting (e.g., transmitting information), input, output, and accessing (e.g., accessing data in memory). Moreover, the terms “determining” and “deciding”, may be deemed to include, for example, resolving, selecting, choosing, establishing, and comparing (comparing). Namely, “determining” and “deciding” may include deeming that some operation is determined or decided.

The expression “on the basis of” used in the present specification does not mean “on the basis of only” unless otherwise stated particularly. In other words, the expression “on the basis of” means both “on the basis of only” and “on the basis of at least”.

As long as “include”, “including”, and variations thereof are used in the specification or claims, these terms are intended to be inclusive in a manner similar to the term “comprising”. Furthermore, the term “or” used in the specification or claims is intended to be not an exclusive “or”.

In the entirety of the present disclosure, articles, such as a, an, or the in English that are added to a noun term by translation may indicate a plurality of the noun terms unless the articles obviously indicate a singular noun from the context.

While the invention has been described in detail, it will be apparent to those skilled in the art that the invention is not limited to the embodiments described herein. The invention can be implemented as modifications and modifications without departing from the spirit and scope of the invention as defined by the appended claims. Accordingly, the description herein is intended for illustrative purposes and does not have any limiting significance to the present invention.

### Description of Reference Signs

101 transmitter
102 receiver
103 configuration information manager
104 controller
201 transmitter
202 receiver
203 configuration information manager
204 controller
1001 processor
1002 memory
1003 storage
1004 communication device
1005 input device
1006 output device

1. A communication apparatus comprising:
a receiver configured to receive control information for a specified communication apparatus from a base station; and
a transmitter configured to identify, based on the control information, a resource used by the specified communication apparatus for communication, and to execute a process of not performing transmission using the identified resources.

2. The communication apparatus according to claim 1, wherein
the transmitter executes, as the process, a process of selecting a transmission resource used for transmission from resources excluding the identified resource.

3. The communication apparatus according to claim 1, wherein
the transmitter executes, as the process, a process of dropping of transmission to which the identified resource has been allocated.

4. The communication apparatus according to claim 1, wherein
the transmitter executes the process, in response to the receiver detecting specific information from the control information.

5. The communication apparatus according to claim 1, further comprising:
a controller configured to determine whether the specific communication apparatus is within coverage of the base station or is outside the coverage of the base station, wherein
the transmitter does not perform the process, in response to the controller determining that the specific communication apparatus is outside the coverage of the base station.

6. The communication apparatus according to claim 2, wherein
the transmitter executes, as the process, a process of dropping of transmission to which the identified resource has been allocated.

7. The communication apparatus according to claim 2, wherein
the transmitter executes the process, in response to the receiver detecting specific information from the control information.

8. The communication apparatus according to claim 3, wherein
the transmitter executes the process, in response to the receiver detecting specific information from the control information.

9. The communication apparatus according to claim 2, further comprising:
a controller configured to determine whether the specific communication apparatus is within coverage of the base station or is outside the coverage of the base station, wherein
the transmitter does not perform the process, in response to the controller determining that the specific communication apparatus is outside the coverage of the base station.

10. The communication apparatus according to claim 3, further comprising:
a controller configured to determine whether the specific communication apparatus is within coverage of the base station or is outside the coverage of the base station, wherein
the transmitter does not perform the process, in response to the controller determining that the specific communication apparatus is outside the coverage of the base station.

11. The communication apparatus according to claim 4, further comprising:
a controller configured to determine whether the specific communication apparatus is within coverage of the base station or is outside the coverage of the base station, wherein
the transmitter does not perform the process, in response to the controller determining that the specific communication apparatus is outside the coverage of the base station.
